(19) United States
(12) Patent Application Publication
(10) Pub. No.: US 2025/0101716 A1
(43) Pub. Date: Mar. 27, 2025

(54) WORK MACHINE COMPONENT

(71) Applicant: ITALTRACTOR ITM S.P.A, Bologna (IT)

(72) Inventors: Askar ECHAMANOV, Bologna (IT); Eustachio CALIA, Matera (IT); Adriano BELLINI, Bologna (IT); Stefano SALSI, Bologna (IT)

(21) Appl. No.: 18/832,174

(22) PCT Filed: Jan. 26, 2023
(86) PCT No.: PCT/IB2023/050676

§ 371 Date: Jul. 23, 2024

(30) Foreign Application Priority Data
Jan. 27, 2022 (IT) 102022000001370

(51) Int. Cl. E02F 9/26

(52) U.S. Cl. CPC E02F 9/267

(57) ABSTRACT

A work machine component including a cavity formed in the component and having an extension axis, an opening for the cavity placed at an outer surface of the component, a support body having an axial extension axis parallel to the extension axis of the cavity and inserted in the cavity. The support body includes, at a first axial end, a top surface and at least one housing seat configured to receive a wear sensor. The housing seat includes a top wall placed at a distance along the axial extension axis from the top surface of the support body. A wear sensor is housed in the housing seat.

### FIELD OF THE INVENTION

The present invention relates to a component of a work machine such as an earth moving machine, a mining machine, a demolition machine and the like.

### BACKGROUND

Such types of machines are usually installed on movement structures known as undercarriages to allow the machine to be able to be moved on ground that is often uneven or loose.

An undercarriage typically comprises two chain assemblies distanced from one another and arranged parallel, configured to receive a torque and transfer it to the ground.

Each chain assembly comprises a plurality of undercarriage components that usually comprise a closed loop chain on a drive wheel and an idler wheel operatively connected to a tensioning unit. The undercarriage components further comprise, between the drive wheel and the idler wheel, a plurality of rollers configured to guide the chain during the motion thereof and to absorb the loads transmitted by the machine.

The chain usually comprises a plurality of joints rotatably connected to each other at respective ends. Each joint comprises a pair of links facing each other. The links of each joint are usually interconnected by pins and bushes. Each pin is usually inserted in holes provided on the links to connect two links together. The bushes are usually placed radially outside the pins to distance the links of the joints from one another, protecting the pins from the external environment and to mesh the drive wheel. The soles are usually mounted on the joints which, being in direct contact with the ground, have the task of discharging the traction to the ground and increasing the contact surface between machine and ground. The type of sole used depends on the ground on which the machine must operate, on the conditions of the environment in which the machine must operate and on the specifications suggested by the machine manufacturer.

The undercarriage is usually subjected to very demanding operating conditions, both due to the total weight of the machine, and the high power transferred by the machine engine to the ground, and the conformation and composition of the ground on which the machine is to operate.

The undercarriage components, like other components of the work machine such as the bucket, the ripper, the loader, the bucket teeth, the loader teeth and the ripper teeth, are therefore subjected to high mechanical stress that can cause damage and wear to the components themselves.

Wear is one of the reasons for machine downtime for performing repair interventions or replacement of components of the work machine to guarantee the correct operation thereof.

The Applicant has verified that the correct planning of machine downtime enables the performance of the machine, in terms of production, to be optimized. In particular, the Applicant has verified that to optimize the production performance of the work machine, the latter should be stopped and subjected to repair interventions or replacement of components before wear phenomena cause the machine to break down and therefore a forced and sudden stop. The Applicant has also verified that, at the same time, the optimization of the production performance of the work machine cannot anticipate machine downtime for the repair or replacement of components that are not effectively compromised or close to effective breakdown, as the total machine downtimes would be unjustifiably long.

The Applicant has noted that in order to be able to predict breakdowns due to excessive wear of one or more components of the work machine and prevent having to replace or repair components that still work correctly, it would be important to be able to know the current wear condition of the components or however of the components most subject to wear.

The Applicant has hypothesized that it may be possible to predict the state of wear of a work machine component by making use of statistical considerations on the rate of wear of the component knowing, for each type of machine and component and for each type of working condition of the machine, the mean operating life (in terms of operating hours of the machine) of each component.

The Applicant has however verified that such statistical considerations are not reliable as there are too many, often interconnected, variables to consider in order to be able to obtain significant data and able to effectively estimate the state of wear of each component.

The Applicant has therefore perceived that it is appropriate to be able to have a direct measurement of the state of wear of one or more components of the work machine in order to be able to effectively predict breakdowns and, at the same time, reduce to a minimum the number of machine downtimes necessary to guarantee the correct operation of the machine.

For that purpose, the Applicant has tried to perform periodic inspections on the state of wear of the components through a visual or instrumental check on the components by qualified personnel.

The Applicant has verified that, for obvious safety reasons, such periodic inspections require an interruption to the operation of the machine with consequent, although limited, machine downtime necessary for performing the inspections.

Furthermore, in accordance with the Applicant's experience, it is not always possible to perform a visual or instrumental check on the components, e.g. undercarriage components, as such components may not be directly reachable (such as, for example, in the case of pins or elements inside the rollers) or they may be covered in mud, dirt and the like (very often present in typical environments where the machines operate).

Document US 2015/0081166 describes a system for monitoring the wear on undercarriage components that comprises a sensor device having a probe configured to measure wear-related information. The probe may be a resistance with one or more resistors configured so that as the probe gets worn a resistance value associated with the probe changes. The change in resistance value is connected with the amount of material that has been removed due to wear from the undercarriage component. The probe is placed in proximity to or in contact with the undercarriage component.

Document WO2021/105941 on behalf of the same Applicant describes a work machine component comprising a cavity formed in the component having an extension axis and delimited by a side wall, an opening for the cavity placed at an outer surface of the component, a wear sensor housed in the cavity and comprising a first axial end placed at the opening for the cavity, a support body inserted in the cavity with a first axial end aligned with the first axial end of the wear sensor. The support body is connected to the side wall of the cavity and constrained to the side wall of the cavity, and the wear sensor is physically connected to the support body and is constrained, at least in an axial direction, to the support body.

The Applicant believes that systems such as those described in US 2015/0081166 and WO2021/105941 can provide indications on the current state of wear of a work machine component.

The Applicant has noted that wear sensors such as those described in WO2021/105941 need to be constantly and directly exposed, together with the work machine component whose wear status is to be monitored, to erosive agents in order to wear out and provide corresponding electrical signals indicative of the degree of wear.

The Applicant has noted, however, that wear sensors, by their nature, have an infinitely lower resistance to wear than the work machine component whose wear status is to be monitored.

Moreover, in accordance with the Applicant's experience, the wear sensor is entrusted precisely with the function of wearing out as soon as it is exposed to the erosive agents responsible for the wear of the machine component, such as debris, rock fragments or other bodies of various nature, shape and size.

The Applicant has found, however, that when the erosive agents responsible for the wear of the machine component reach the wear sensor, the wear sensor could in some unfavourable cases be much more eroded than the machine component, substantially wearing out before the machine component and providing an overestimation of the actual wear condition of the work machine component.

The Applicant has therefore perceived that in order to have reliable and certain indications of the state of wear of a work machine component, it must be ensured that the wear sensor cannot wear out before the work machine component whose wear status is to be monitored.

### SUMMARY

The Applicant has found that by exposing the wear sensor to the erosive agents responsible for the wear of the work machine component only at the time when such erosive agents had actually worn the machine component, it would be possible to prevent the wear sensor from wearing before the work machine component.

Therefore, the present invention relates to a work machine component comprising a cavity formed in the component and having an extension axis, an opening for the cavity placed at an outer surface of the component.

A support body is provided, having an axial extension axis parallel to said extension axis of the cavity, inserted in the cavity and comprising, at a first axial end, a top surface.

The support body comprises at least one housing seat cavity formed in said support body and configured to receive a wear sensor, in which said housing seat comprises a top wall placed at a distance, along said axial extension axis, from the top surface of the support body.

A wear sensor is housed in said housing seat.

The Applicant has verified that the wear of the surface of the work machine component causes wear of the support body. The Applicant has perceived that by providing a housing seat for the wear sensor which has a top wall, the wear sensor is not exposed to erosive agents as long as such a top wall of the housing seat is present. Only when the top wall of the housing seat erodes due to wear, is the wear sensor then exposed to the erosive agents and can also be worn out, providing an indication representative of the wear condition of the work machine component.

Thereby, the wear sensor cannot provide any accidental signal of wear, as it is only when the actual wear threshold of the work machine component is reached that the wear sensor can be exposed to erosive agents.

The term “work machine component” or “component” means a component of the work machine that is subject to loads, stress and strain that can cause wear on the component itself. Examples of work machine components are the bucket, the ripper, the loader, the teeth of the bucket, of the loader and of the ripper, an undercarriage component.

The term “undercarriage component” means any component from among a drive wheel, an idler wheel, a pin, a bush, a link, a link plate, a roller, a sole, of an undercarriage.

The cavity in the component has an extension axis along which the cavity is formed. Such an extension axis can coincide with an axis of symmetry of the cavity in the event in which the cavity is substantially cylinder shaped.

The terms ‘axial’, ‘axially’, ‘radial’, ‘radially’, ‘circumferential’ and ‘circumferentially’ are used with reference to the support body.

In particular, the terms ‘axial’ and ‘axially’ are meant as references/sizes arranged/measured or extending in a substantially parallel direction to the extension axis of the support body.

The terms ‘radial’ and ‘radially’ are meant as references/sizes arranged/measured or extending in a substantially perpendicular direction to the extension axis of the support body and lying in a perpendicular plane to such an extension axis.

The terms ‘circumferential’ and ‘circumferentially’ are meant as references/sizes arranged/measured or extending in a substantially angular direction around the extension axis of the support body and lying in a perpendicular plane to such an extension axis.

The terms ‘radially inner/outer’ are meant as respectively a position closer to or farther away from the aforesaid extension axis of the support body.

Preferably, the extension axis of the support body is perpendicular to the surface of the work machine component whose wear status is to be monitored.

The term ‘sensor’ is meant as a device that is in direct interaction with the measured system, i.e., the first element of a measurement chain that converts the process variable into a measurable signal.

The term ‘wear’ refers to the progressive loss of material from the surface of a body. When it refers to a component, it means the gradual loss of material from a surface of the component.

The expression ‘mechanical properties’ when it refers to a body or to a structure is meant as at least one from among the mechanical resistance (defined as the capacity to withstand static stress), resilience (defined as the capacity to withstand dynamic stress), the hardness (defined as resistance to localized plastic deformations), fatigue resistance (defined as the capacity to withstand periodic stress).

The present invention can comprise at least one of the preferred features described below.

Preferably, said housing seat comprises an abutment wall facing toward said first axial end, said wear sensor comprising a measuring portion axially placed between said top wall and said abutment wall.

The Applicant has found that, following the wear of the top wall of the housing seat, and the consequent exposure of the wear sensor to the external environment, the wear sensor could be accidentally moved inside the housing seat before indicating the wear of the component. This possibility makes the detection of the wear of the component less reliable. The provision of an abutment wall facing toward the first axial end and the arrangement of the measuring portion of the wear sensor between the abutment wall allows the abutment wall to stop the measuring portion during the detection of component wear.

Preferably, said abutment wall has an angle with said axial extension axis comprised between 45° and 135°, preferably 60° and 120°, more preferably between 75° and 105°, even more preferably between 85° and 95°, e.g., 90°.

Preferably, said abutment wall is parallel to the top wall in the radial direction.

Thereby, as a result of wear of the top wall, external agents would stress the measuring portion directly against the abutment wall.

Preferably said measuring portion can be worn.

Preferably, such a measuring sensor is configured to detect a state of wear of the work machine component directly as a result of a degradation of the measuring portion.

Preferably, said housing seat comprises a radial recess defined between the top wall and the abutment wall, said radial recess being extended radially towards said axial extension axis, said measuring portion being inserted within said radial recess.

Inserting the measuring portion into a radial recess reduces the possibility of movement of the measuring portion.

Preferably, said radial recess is a hole extended towards said axial extension axis.

Preferably, said hole is cylindrical.

Preferably, said hole is extended radially up to said axial extension axis.

Preferably, said housing seat comprises an axial channel extended parallel to said axial extension axis, from said radial recess to a second axial end of said support body, axially opposite said first axial end.

Preferably, said housing seat has an ‘L’ shape in which said axial channel and said radial recess form respective branches of said ‘L’ shape.

Preferably, said axial channel is a groove formed on a lateral surface of the support body.

Preferably, said groove is axially rectilinear.

Preferably, said housing seat comprises an edge between said radial recess and said axial channel.

Preferably, said edge is a sharp edge.

Preferably said edge is defined between said abutment wall and said axial channel.

Preferably, said edge defines an angle comprised between 45° and 135°, preferably between 75° and 105°, even more preferably between 85° and 95°, particularly around 90°.

Preferably, said edge is defined between said abutment wall and an abutment wall of the axial channel.

Preferably, said wear sensor forms a curve at said edge.

The Applicant has found that forming a curve of the measuring sensor on an edge of the housing seat helps to influence measurable electrical properties of the measuring sensor when the support body wears down to the abutment wall.

Preferably, said curve is formed between the conductive portion and the measuring portion.

Preferably said housing seat comprises a base opening.

Preferably, said base opening is placed at the second end of the support body.

Preferably, said base opening is perpendicular to said axial extension axis.

Preferably, said wear sensor comprises an electrically conductive portion connected to the measuring portion.

Preferably, said conductive portion is housed in said axial channel.

Preferably, said conductive portion extends through said base opening.

Preferably, said measuring portion extends radially.

Preferably, said conductive portion extends axially.

Preferably, said cavity comprises an inner screw thread.

Preferably, said support body comprises an outer screw thread.

Preferably, the outer screw thread of the support body is engaged with the inner screw thread of the cavity.

Preferably, the inner screw thread and the inner screw thread are configured to allow the support body to be screwed in the cavity up to a limit switch position.

Preferably, said support body is permanently retained in said cavity in a predetermined position.

Preferably, said predetermined position corresponds to said limit switch position.

Preferably, said support body comprises a manoeuvring portion configured to allow said support body to be rotated within said cavity by means of a tool counter-shaped to said manoeuvring portion.

Preferably, said manoeuvring portion comprises a manoeuvring recess open in said top surface.

Preferably, said manoeuvring recess comprises a hexagonal hole.

Preferably, said top surface is aligned with the outer surface of the component.

Preferably, said top surface is aligned with the outer surface of the component in the predetermined position of the support body.

Since the support body is aligned, with its top surface, to the surface of the work machine component whose wear is to be monitored, as the surface of the undercarriage component wears, the support body also wears starting from the top surface.

Preferably, said top wall is placed at a predetermined distance, along said axial extension axis, from the top surface of the support body.

The Applicant has found that by arranging such a top wall of the housing seat at a predetermined distance in the direction of the axial extension axis of the support body, it is possible to choose such a predetermined distance so that it corresponds to a predetermined degree of wear of the support body (and thus of the work machine component) indicative of the replacement of the work machine component or regardless indicative of a predetermined wear threshold of the work machine component.

Preferably, said top wall is placed at a predetermined distance, along said axial extension axis, from the outer surface of the component.

Preferably, said predetermined distance is measured in the predetermined position of the support body.

Preferably, the predetermined distance of the top wall from the top surface of the support body and/or the outer surface of the component is greater than 0.5 centimetres, preferably comprised between 0.5 centimetres and 5 centimetres, preferably comprised between 0.5 centimetres and 3 centimetres, preferably between comprised 0.5 centimetres and 2 centimetres, e.g., 1 centimetre.

Preferably, said support body comprises a plurality of housing seats formed in said support body.

Preferably, a plurality of wear sensors is provided in which each wear sensor of said plurality of wear sensors is inserted in a corresponding housing seat.

Preferably, each wear sensor is connected to a device for processing or conditioning a signal coming from the wear sensor.

Preferably, each housing seat of said plurality of housing seats comprises a respective top wall placed at a distance, along said axial extension axis, from the top surface of the support body.

Preferably, each top wall is placed at a predetermined distance, along said axial extension axis, from the top surface of the support body and/or from the outer surface of the component.

Preferably, each housing seat of said plurality of housing seats comprises an abutment wall facing toward said first axial end.

Preferably, each wear sensor of said plurality of wear sensors comprises a measuring portion axially placed between the top wall and the abutment wall of the respective housing seat.

Preferably, each housing seat of said plurality of housing seats comprises a radial recess defined between the respective top wall and the respective abutment wall, said radial recess being extended radially towards said axial extension axis.

Preferably, the measuring portion of each wear sensor is inserted within the radial recess of the respective housing seat.

Preferably, each housing seat of said plurality of housing seats comprises a respective axial channel extended parallel to said axial extension axis, from the respective radial recess towards a second axial end of said support body, axially opposite said first axial end.

Preferably, each axial channel is a groove formed on a lateral surface of the support body.

Preferably, each wear sensor of said plurality of wear sensors comprises a respective conductive portion electrically connected to the respective measuring portion, the conductive portion of each sensor being housed in the axial channel of the respective housing seat.

Preferably, said predetermined distances of the top walls of said plurality of housing seats are different from each other.

Preferably, said predetermined distances different from each other are chosen so that each predetermined distance corresponds to a predetermined degree of wear of the work machine component.

Preferably, at least one of said predetermined distances is chosen so as to correspond to a predetermined maximum degree of wear of the work machine component.

Preferably, when said maximum degree of wear of the work machine component is reached, it is envisaged to replace the work machine component.

Preferably, said maximum degree of wear of the work machine component is less than a failure degree of wear of the work machine component.

Preferably, each housing seat of said plurality of housing seats is placed at a distance in a circumferential direction from another housing seat.

Preferably, each housing seat of said plurality of housing seats is equidistant in the circumferential direction from two circumferentially adjacent housing seats.

In an embodiment, said at least one housing seat is a groove formed on a lateral surface of the support body.

Preferably, each housing seat comprises said top wall and two side walls.

Preferably, each housing seat extends in the axial direction.

Preferably, said two side walls are substantially rectilinear.

Preferably, each housing seat comprises a support wall delimited by said top wall and said two side walls.

Preferably, each housing seat is open in a radial direction.

Preferably, each housing seat is open in a radial direction along the entire extension of said two side walls.

Preferably, each housing seat comprises a base opening axially opposite the top wall.

Preferably, each wear sensor is constrained in the respective housing seat.

Preferably, each wear sensor is glued in the respective housing seat.

Preferably, each wear sensor comprises a measuring portion which can be worn and is configured to change, when eroded, measurable electrical properties of the wear sensor.

Preferably, the erosion of the wear sensor changes said measurable electrical properties.

Preferably, the measurable electrical properties can be electrical resistance, electrical capacitance or inductance considered individually or in combination.

Preferably, the measurable electrical properties are electrical resistance.

Preferably, the mechanical properties of the support body are different from the mechanical properties of the wear sensor.

Preferably, each wear sensor is an electrical conductor.

Preferably, said wear sensor is a single wire of electrically conductive material.

Preferably, said wear sensor is a single wire of electrically conductive material forming a U-bend at the top wall of the housing seat.

Preferably, said measuring portion comprises said U-bend.

Preferably, when the support body is worn down to the point of eliminating the top wall of the housing seat, said U-bend of the single wire of conductive electrical material is exposed to erosive agents.

Preferably, said single wire of conductive electrical material is configured to break at said U-bend when exposed to erosive agents.

Preferably, said single wire of conductive electrical material can comprise a single filament or multiple filaments woven or twisted together.

Preferably, said single wire of electrically conductive material comprises a sheath of electrically insulating material which completely surrounds the single filament or multiple filaments of the electrically conductive material.

Preferably, a ratio between the resistance to localized plastic deformations of the material that constitutes the support body and the resistance to localized plastic deformation of the material of the component surrounding the cavity is less than 1.6, where the resistances to localized plastic deformations of the support body and of the component are measured with a Brinell scale with identical test conditions; or the ultimate tensile strength of the material that constitutes the support body is less than 160% of the ultimate tensile strength of the component surrounding the cavity.

An example of test conditions that can be used for measuring the hardness according to the Brinell scale can be found in standard ISO 6506-1:2015.

The resistance to concentrated plastic deformations of the material is the hardness of the material.

Should the hardness of the support body (or of the component) not be measurable with a Brinell scale using identical test conditions for measuring the hardness of the component (or of the support body), or in the event that it is not possible to accurately determine the hardness of the support body or of the component using a Brinell scale, it is preferable to refer to the ratio between the ultimate tensile strength of the material that constitutes the support body and the ultimate tensile strength of the material that constitutes the component for comparing the two hardnesses.

The ultimate tensile strength for metallic materials is preferably determined according to standard ISO 6892-1:2016. The ultimate tensile strength for plastic or polymer materials is preferably determined according to standard ISO 527-1:2019.

The Applicant has found that too high a hardness of the support body with respect to the hardness of the component could expose the support body axially (subject to less wear with respect to the outer surface of the component) beyond the outer surface of the component.

Preferably, the ratio of the resistance to localized plastic deformations of the material constituting the support body to the resistance to localized plastic deformations of the material of the component surrounding the cavity is equal to or greater than 0.20, more preferably equal to or greater than 0.35, more preferably equal to or greater than 0.55, more preferably equal to or greater than 0.80, more preferably equal to or greater than 0.95, where the resistances to localized plastic deformations of the support body and the component are measured using a Brinell scale with identical test conditions; or the ultimate tensile strength of the material constituting the support body is equal to or greater than 20%, more preferably equal to or greater than 35%, more preferably equal to or greater than 55%, more preferably equal to or greater than 80%, more preferably equal to or greater than 95%, of the ultimate tensile strength of the material of the component surrounding the cavity.

Preferably, the ratio of the resistance to localized plastic deformations of the material constituting the support body to the resistance to localized plastic deformations of the material of the component surrounding the cavity is equal to or less than 1.40, more preferably equal to or less than 1.30, more preferably equal to or less than 1.25, more preferably equal to or less than 1.15, more preferably 1.05, where the resistances to localized plastic deformations of the support body and the component are measured using a Brinell scale with identical test conditions; or the ultimate tensile strength of the material constituting the support body is equal to or less than 140%, more preferably equal to or less than 130%, more preferably equal to or less than 125%, more preferably equal to or less than 115%, more preferably equal to or less than 105%, of the ultimate tensile strength of the material of the component surrounding the cavity.

Preferably, the ratio between the resistance to localized plastic deformation of the material that constitutes the support body and the resistance to localized plastic deformation of the material of the component surrounding the cavity is equal to 1, where the resistance to localized plastic deformation of the support body and of the component are measured with a Brinell scale with identical test conditions; or the ultimate tensile strength of the material that constitutes the support body is greater than or equal to 100% of the ultimate tensile strength of the component surrounding the cavity.

Preferably, the support body is made of metal. Examples of metals that can be used for making the support body are steel, stainless steel, bronze, brass, cast iron, aluminium alloys.

Preferably, the support body and the component are made of the same material.

In some embodiments of the invention, the support body can be made of polymer material, such as for example aliphatic polyamides (such as nylon and ertalon) and aromatic polyamides (such as kevlar).

In fact, the Applicant has found that during normal use of the component, the support body is subjected to dynamic loads (as well as static loads) that can generate undesired vibrations in the support body.

By arranging the support body in polymer material, such vibrations can be dampened.

Preferably, the support body has a radial section, obtained along a radial plane passing through said top surface, having an area equal to or less than the area subtended by the cavity on a section obtained along a radial plane passing through said opening for the cavity.

Preferably, the support body has a radial section, obtained along a radial plane passing through said top surface, having an area of at least 95% of the area subtended by the cavity on a section obtained along a radial plane passing through said opening for the cavity.

Preferably, the area of said radial section is constant, along the axial extension of the support body, between the top surface and the top wall of said at least one housing seat.

Preferably, at least between the top surface of the support body and the top wall of the housing seat closest to the top surface, the support body has a radial section having constant area and constant shape.

Preferably, the base opening of each housing seat is configured for at least one electrical conductor to pass through.

Preferably, each wear sensor is inserted in the respective housing seat so that said wear sensor is contained within the projection in the axial direction of the top surface of the support body.

Preferably, the height of said two side walls of each housing seat in the radial direction is at least equal to a diameter of said single wire of electrically conductive material.

Preferably, the distance between said two side walls of each housing seat in the circumferential direction is at least equal to twice a diameter of a single wire of electrically conductive material.

Preferably, at least when the support body is inserted in the cavity, the wear sensor does not rub against cavity walls.

Preferably, the support body has a substantially cylindrical shape between the top surface and the top wall of the housing seat farthest from the top surface.

Preferably, said cavity has the shape of a cylinder with a constant diameter.

According to a first variant embodiment, said support body preferably comprises an insertion portion extending between said base opening and a second axial end of the support body.

Preferably, said insertion portion has a radial section, measured at any point along the axial extension of the support body, having an area less than the area of the radial section of the support body obtained along a radial plane passing through said top surface.

Preferably, said radial section of the insertion portion has an area smaller than the area of the radial section of the cavity measured at the same point.

Preferably, the support body has a substantially cylindrical shape at the insertion portion.

Preferably, the support body has the shape of a first cylinder at the insertion portion and a second cylinder superimposed on said first cylinder.

According to a second variant embodiment, the support body has a radial section, measured at any point along the axial extension of the support body, which is substantially constant along the entire axial extension of the support body.

Preferably, said radial section of the insertion portion has a diameter equal to the diameter of the radial section of the cavity measured at the same point decreased by at least twice the diameter of said single wire of electrically conductive material.

Preferably, the support body extends in the axial direction for the entire length in the axial direction of the cavity.

Preferably, the volume of the support body is equal to at least 75% of the volume of the cavity.

Preferably, the volume of the support body is equal to at least 90% of the volume of the cavity.

Preferably, the volume of the support body is equal to at least 95% of the volume of the cavity.

Preferably, said housing seat is filled with epoxy resin.

Preferably, the support body is constrained to the side wall of the cavity through the use of said epoxy resin. An example of epoxy resin that can be used is a two-component epoxy thixotropic resin that is resistant to heat and to chemical agents such as, for example, the product Elantas ADH 50.50.

In this case, the support body is preferably inserted with radial clearance within the cavity.

Preferably, the extent of the radial clearance between the support body and the cavity is less than 2 millimetres.

Preferably, the extent of the radial clearance between the support body and the cavity is less than 1.5 millimetres.

Preferably, the extent of the radial clearance between the support body and the cavity is less than 1.0 millimetre.

Preferably, the extent of the radial clearance between the support body and the cavity is less than 0.5 millimetres.

Radial clearance between the support body and the cavity means the displacement in the radial direction of the support body between two radially opposite positions in which each position the support body is in contact with the side wall of the cavity.

Alternatively, the support body is inserted with mechanical interference into the cavity. In other words, along at least one radial plane, the maximum dimension in the radial direction of the support body is preferably greater than the minimum dimension in the radial direction of the cavity.

### BRIEF DESCRIPTION OF THE DRAWINGS

Further features and advantages of the invention will be more evident from the following description of a preferred embodiment thereof, made with reference to the appended drawings. In such drawings:

FIGS. 1 and 2 are schematic sectional views of a part of a work machine component according to a first embodiment and in accordance with the present invention;

FIGS. 1A and 2A are schematic sectional views of a part of a work machine component according to a second embodiment and in accordance with the present invention;

FIG. 3 is a perspective view of a detail of the work machine component of FIG. 2;

FIG. 4 is a bottom view of the detail of FIG. 3;

FIGS. 5 and 6 are a front and side view of the detail of FIG. 3;

FIG. 7 is a front view of a detail of the component of FIG. 2;

FIG. 8 is a front view of a detail of the component of FIG. 2A; and

FIG. 9 is a schematic view of an electrical circuit that can be used in the component of FIG. 2 and FIG. 2A;

FIGS. 10 and 10A are schematic sectional views of a part of a work machine component according to a third embodiment and in accordance with the present invention;

FIG. 11 is a front view of a detail of the work machine component of FIG. 10A;

FIGS. 12 to 14 are sectional views of the detail of FIG. 10A according to respective different cutting planes;

FIG. 15 is a top view of the detail of FIG. 10A;

FIG. 16 is a bottom view of the detail of FIG. 10A.

### DETAILED DESCRIPTION

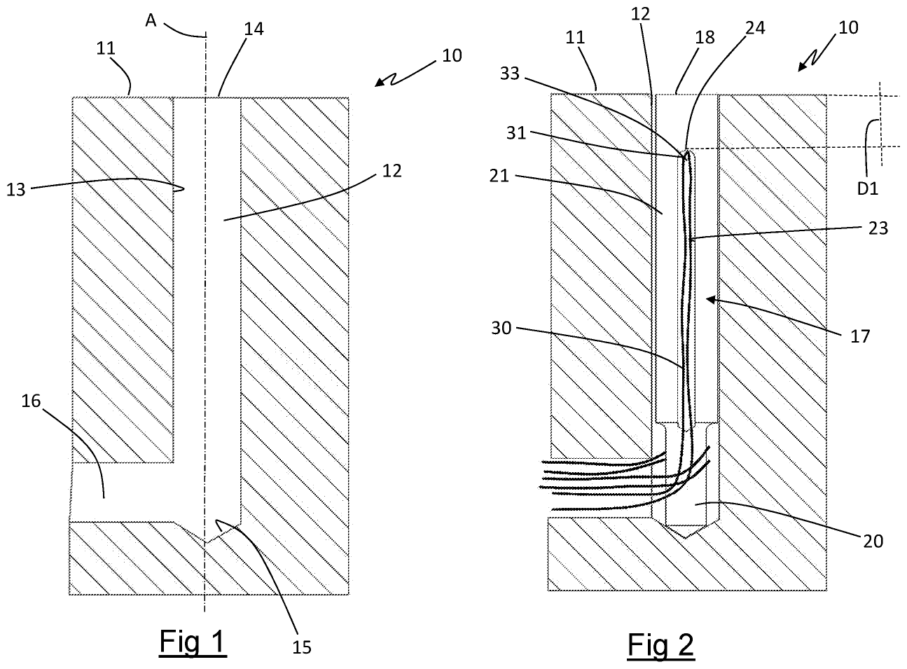

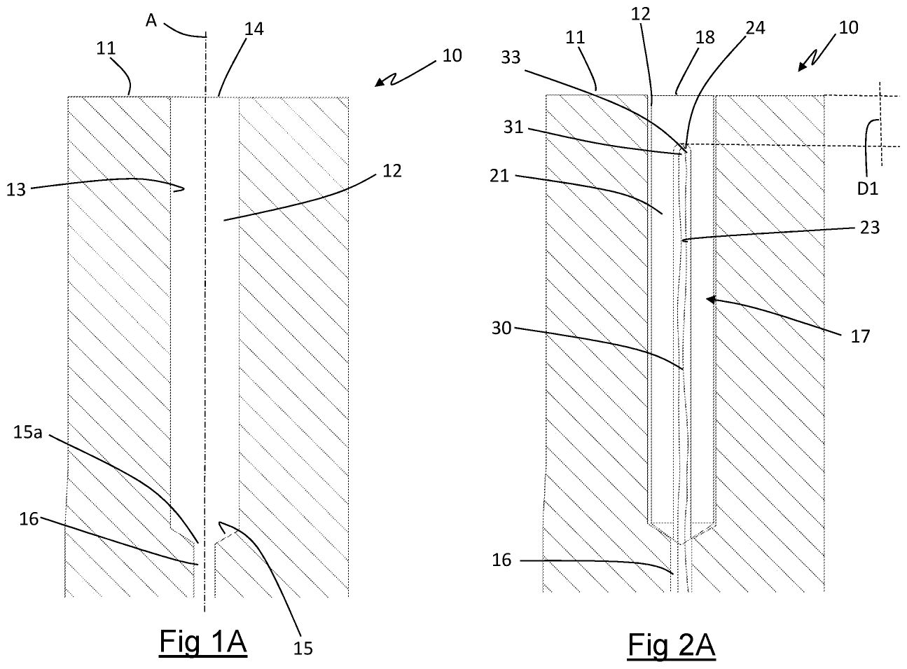

With reference to FIGS. 1, 2, 1A and 2A with 10, a first and a second embodiment of a work machine component in accordance with the present invention are collectively indicated.

The work machine component 10 is, for example, an undercarriage component and reference will be made thereto below as an example of a work machine component. The undercarriage component 10 can for example be a drive wheel or an idler wheel or a pin or a bush or a link or a link plate or a roller or a sole of an undercarriage.

As shown in FIGS. 1 and 1A, the undercarriage component 10 comprises an outer surface 11 which is intended to interact with a work surface (not illustrated) which can for example be the outer surface of another undercarriage component or the ground.

The outer surface 11 of the undercarriage component 10 is the surface of which the state of wear is to be monitored.

In the undercarriage component 10, a cavity 12 is obtained which is delimited by a side wall 13. The cavity 12 can, for example, be formed by boring with a drill bit and have a substantially cylindrical shape.

The cavity 12 comprises an opening 14 for the cavity placed at the outer surface 11 of the component 10.

The cavity 12 further comprises a bottom wall 15, opposite the opening 14, which can be truncoconical as depicted in FIGS. 1 and 1A. Such a truncoconical shape is obtained by boring the cavity 12 using a drill bit.

The bottom wall 15 can be closed (as illustrated in FIG. 1) or open (as illustrated in FIG. 1A), i.e., it can be a continuous wall or a wall which comprises an opening 15a.

In other embodiments not illustrated, the shape of the cavity 12 may be a straight prism with a polygonal base, an oblique prism with a polygonal base or a truncated pyramid.

The cavity 12 preferably has a constant radial section along its axial development.

The cavity 12 has an extension axis A along which the cavity itself extends. The extension axis A passes through the opening 14 and extends deep into the bottom wall 15. In the case of a substantially cylindrical shaped cavity (as shown in FIG. 1) the extension axis A coincides with an axis of symmetry for the cavity 12.

A passage channel 16 is provided at the bottom wall 15.

If the bottom wall 15 is closed, as illustrated in FIGS. 1 and 2, the passage channel 16 reaches the side wall 13 of the cavity 12.

If the bottom wall is open, as illustrated in FIGS. 1A and 2A, the passage channel extends from the opening 15a in the bottom wall 15.

In both cases, the passage channel 16 puts the cavity 12 in communication with a further surface (not shown) of the work machine component 10 and is preferably obtained by boring.

The undercarriage component 10 further comprises a support body 17 inserted in the cavity 12, as shown in FIG. 2.

The support body 17 comprises a first axial end 17a and a second axial end 17b opposite the first axial end 17a. The support body 17 comprises a substantially flat top surface 18. The top surface 18 is placed at the first axial end 17a. On the opposite side with respect to the top surface 18, the support body 17 comprises a base surface 19. The base surface 19 is placed at the second axial end 17b. The base surface 19 is counter-shaped to the bottom wall 15 of the cavity 12. In the embodiments illustrated, the base surface 19 is substantially truncoconical.

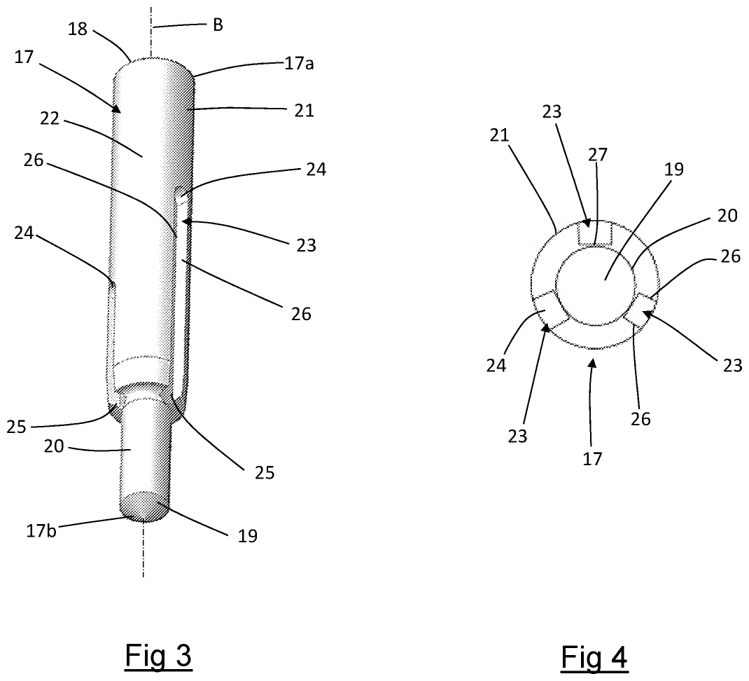

In the embodiment illustrated in FIGS. 3 to 7, the support body 17 comprises an insertion portion 20 extending from the base surface 19 towards the top surface 18.

The support body 17 further comprises a housing portion 21 that extends starting from the insertion portion 20 and reaches the top surface 18.

As illustrated in FIG. 3, the insertion portion 20 has a smaller radial dimension than the radial dimension of the housing portion 21.

The support body 17 extends along an axial extension axis B. Such an axial extension axis B defines, in the preferred embodiment of the invention, an axis of symmetry for the support body 17.

The housing portion 21 is substantially cylindrical in shape and generically defines a first cylinder.

The insertion portion 20 is substantially cylindrical in shape and generically defines a second cylinder.

The first cylinder is superimposed in the axial direction on the second cylinder.

In the embodiment illustrated in FIG. 8, the support body 17 comprises only the housing portion 21 extending starting from the top surface 18 and reaching the base surface 19.

Also in this embodiment, the housing portion 21 is substantially cylindrical in shape.

In both embodiments, the support body 17 comprises a lateral surface 22, extended at the housing portion 21.

Preferably, the support body 17 is made of a material with mechanical properties similar to the mechanical properties of the undercarriage component 10.

In a first preferred embodiment of the present invention, the undercarriage component 10 can be made of abrasion-resistant steel, for example a steel with a low carbon content (comprised between 0.2% and 0.45% by mass). The ultimate tensile strength is comprised between about 1450 Mpa and about 1930 MPa. The hardness is comprised between about 420 HWB and 530 HBW 10/3000. An example of steel that can be used is boron steel with an average carbon content of the 37MnB4 or 25MnB5 type.

The support body 17 can be made of the same material as the undercarriage component 10.

In another embodiment, the support body 17 can be made of stainless steel having an ultimate tensile strength comprised between about 650 and about 800 Mpa and a hardness comprised between about 200 and about 270 HBW 10/3000.

In this last embodiment, the ratio between the hardness of the support body 17 and of the undercarriage component 10 is comprised between about 0.38 and about 0.64. The ratio between the ultimate tensile strength of the support body 17 and of the undercarriage component 10 is comprised between about 0.34 and about 0.55.

In a further embodiment, the support body 17 is made of thermoplastic material such as, for example, Ertalon PA6 or PA66 having ultimate tensile strength comprised between 54 MPa and 61 MPa.

In this case, the material of the support body 17 does not have similar mechanical properties to those of the undercarriage component.

The support body 17 comprises at least one housing seat 23. In the preferred embodiment of the invention, the support body 17 comprises a plurality of housing seats 23. In the example embodiment shown in the appended drawings, three housing seats 23 are provided.

Each housing seat 23 is delimited in the axial direction by a top wall 24 placed at a predetermined distance D1, D2, D3 from the top surface 18 of the support body 17.

Such predetermined distances D1, D2, D3 are equidistant from each other in the axial direction.

The predetermined distance D1 of the top wall 24 closest to the top surface 18 of the support body 17 can be equal to the distance, in the axial direction separating any two top walls 24, or greater than the distance, in the axial direction separating any two top walls 24, or less than the distance, in the axial direction separating any two top walls 24.

Opposite the top wall 24, each housing seat 23 comprises a base opening 25.

In the embodiment of FIGS. 3 to 7, the base opening 25 is placed at the insertion portion 20 of the support body 17. In other words, the side walls 26 extend in the axial direction until reaching the insertion portion 20.

In the embodiment of FIG. 8, the base opening 25 is placed at the base surface 19.

Between the top wall 24 and the base opening 25, each housing seat 23 comprises two side walls 26. A bearing wall 27 is defined between the side walls 26 and the top part 24.

In the embodiment of FIGS. 3 to 7, the bearing wall 27 is substantially axially aligned with the insertion portion 20 of the support body 17. In other words, the side walls 26 extend in a radial direction within the support body 17 (and in particular within the housing portion 21) until reaching an ideal axial projection of the insertion portion 20.

In the embodiment of FIG. 8, the side walls 26 extend in the radial direction within the support body 17 by an amount greater than an ideal axial projection of the passage channel 16. In other words, the side walls 26 lie on the surface of a first ideal cylinder of smaller radius than a second ideal cylinder defined by the axial projection of the passage channel 16.

In both embodiments, each housing seat 23 is open in a radially outward direction.

Preferably, each housing seat 23 has a substantially rectilinear extension parallel to the radial extension axis B of the support body 17.

As shown in the appended drawings and better depicted in FIG. 4, the housing seats 23 are equidistant from each other in the circumferential direction.

The housing seats 17 are made from corresponding grooves formed on the lateral surface 22 of the support body 17. Such grooves are formed on the housing portion 21 of the support body 17.

The top wall 24 of each housing seat 23 is placed at a predetermined distance D1, D2, D3 from the top surface 18 of the support body 17.

Such predetermined distances D1, D2, D3 are different from each other.

The top walls 24 of the housing seats 23 are placed at different distances from the top surface 18 of the support body 17.

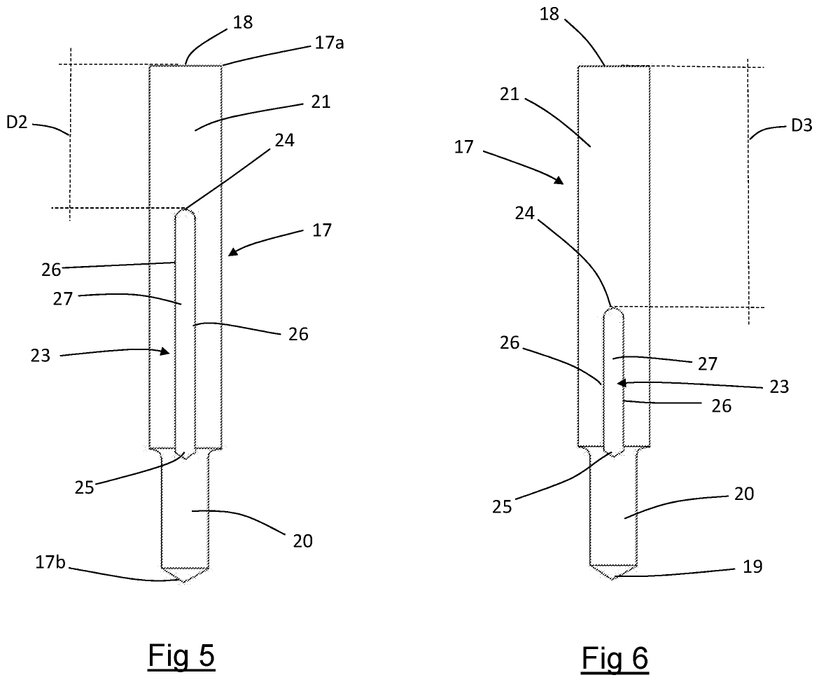

In the example embodiment illustrated in the appended drawings, in which three housing seats 23 are provided, the top wall 24 of a first housing seat 23 is placed at a first predetermined distance D1 (illustrated in FIG. 2), the top wall 24 of a second housing seat 23 is placed at a second predetermined distance D2 (illustrated in FIG. 5) and the top wall 24 of a third housing seat 23 is placed at a third predetermined distance D3 (illustrated in FIG. 6) from the top surface 18 of the support body 17.

None of the housing seats 23 are open in the axial direction towards the top surface 18 of the support body 17.

The top walls 24 of the housing seats 23 close the housing seats 23 in the axial direction towards the top surface 18 of the support body 17.

The support body 17 has a radial section obtained along a radial plane that remains constant (in terms of area and shape) moving axially from the top surface 18 until reaching the top wall 24 closest to the top surface 18 of the support body 17.

A respective wear sensor 30 is housed inside each housing seat 23, as illustrated in FIGS. 2, 7 and 8.

Each wear sensor 30 comprises a measuring portion 31 which can be worn and is configured to change, when eroded, measurable electrical properties of the wear sensor.

The measuring portion 31 is placed at the upper wall 24 of the housing seat 23.

In preferred embodiments of the invention, each wear sensor 30 is an electrical conductor comprising a single wire 32 of electrically conductive material surrounded by a sheath of electrically insulating material.

For example, the single wire 32 of electrically conductive material can be an electric cable comprising a core of metallic material, e.g., copper or aluminium, surrounded by an electrically insulating layer. By way of example, the single wire 32 of electrically conductive material can be a single-core AWG (American wire gauge) 28.

The wear sensor 30 is at least partially housed in the housing seat 23 so that it does not project radially from the dimensions of the upper surface 18 of the support body 17.

In particular, the wire 32 of electrically conductive material which forms the wear sensor 30 is placed in the housing seat 23 so as to create a U-bend 33 at the top wall 24. Such a U-bend 33 defines the measuring portion 31.

To form the U-bend 33, the wire 32 of electrically conductive material is inserted in the housing seat 23 bent so as to define two sections joined by said U-bend 33.

Each wire 32 of electrically conductive material is retained in the respective housing seat 23 by the use of an adhesive.

As schematically illustrated, each wire 32 of electrically conductive material exits from the respective housing seat 23 at the outlet opening 25.

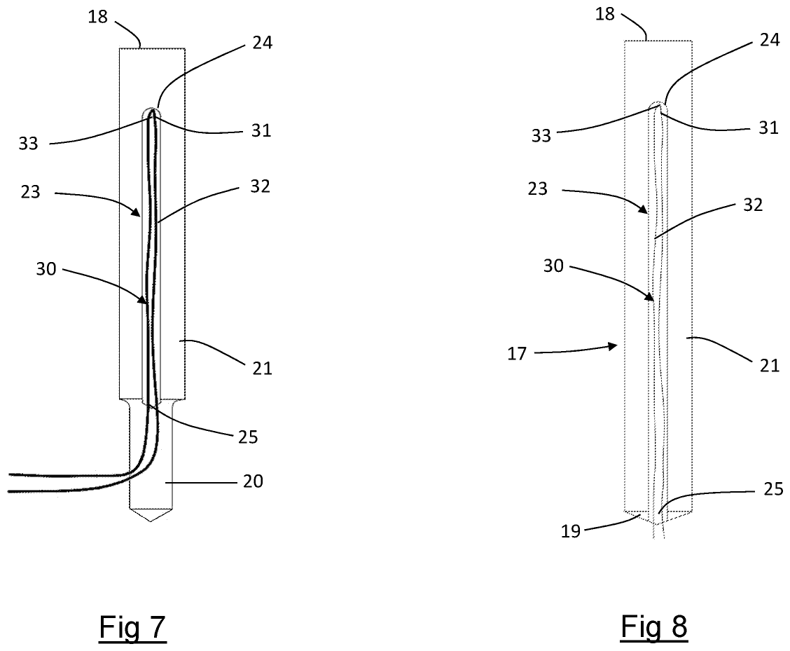

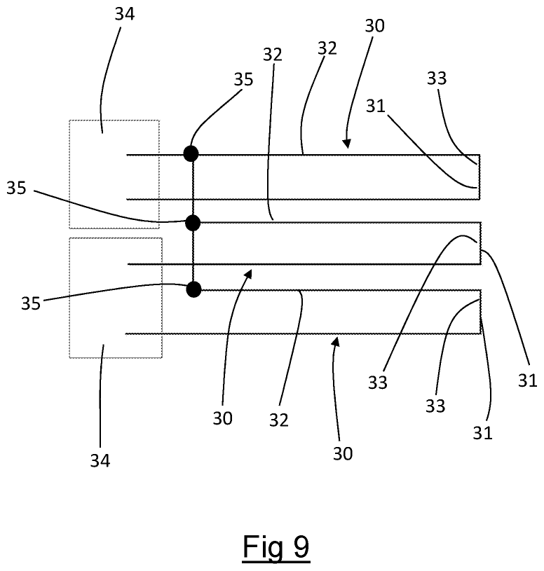

In the embodiment of FIG. 7, each wire 32 of electrically conductive material is arranged at the outlet opening 25 in contact with the insertion portion 20 of the support body 17.

In the embodiment of FIGS. 2A and 8, each wire 32 of electrically conductive material is arranged, at the outlet opening 25, within the passage channel 16.

In both embodiments, on the opposite side with respect to the measuring portion 31, each wear sensor 30 is connected to one or more connectors 34 (diagrammed in FIG. 8) so that it can be inserted in a measuring circuit of a measurable electrical property of the wear sensor 30.

In the preferred embodiment of the invention, such a measurable electrical property of the wear sensor 30 is the electrical resistance.

As diagrammed in FIG. 8, all the wires 32 of electrically conductive material are electrically connected to each other at one end so as to have a common electrical pole 35. By measuring the electrical conductivity (or electrical resistance) between said common electrical pole 35 and the other free end of each wire 32 of electrically conductive material, it is possible to determine the electrical continuity of each wire 32 of electrically conductive material.

The connectors 34 can be connected to a signal processing or conditioning device (not illustrated) which is configured to determine the electrical continuity of each wire 32 of electrically conductive material.

As shown, the support body 17 and the wear sensor 30 (or wear sensors 30 when a plurality of wear sensors 30 are provided) is inserted in the cavity 12.

The support body 17 is inserted in the cavity 12 with the top surface 18 aligned with the outer surface 11 of the work machine component 10 whose wear condition is to be monitored.

The base surface 19 of the support body 17 is placed in contact with the bottom wall 15 of the cavity 12.

The support body 17 is inserted with a radial clearance, albeit minimal, within the cavity 12 and such radial clearance is filled with an epoxy resin. The epoxy resin also fills the housing seats 23 with the wear sensors 30 therein.

In the embodiment of FIGS. 3 to 7, the epoxy resin also fills the radial space between the insertion portion 20 of the support body 17 and the wall 13 of the cavity 12.

In fact, in the embodiment of FIGS. 3 to 7, the cavity 12 has radial sections (along planes parallel to each other and perpendicular to the extension axis A) that are identical to each other, while the support body 17 has radial sections (along planes parallel to each other and perpendicular to the extension axis B) that are different between the insertion portion 20 and the housing portion 21. In particular, radial sections at the insertion portion 20 have smaller areas with respect to the areas of the radial sections at the housing portion 21.

In other words, the space in the radial direction between the housing portion 21 and the wall 13 of the cavity 12 is greater than the space in the radial direction between the insertion portion 20 and the wall 13 of the cavity 12.

During the insertion of the support body 17 within the cavity 12, the wear sensors 30 do not rub against the walls of the cavity 12, as they are completely contained, in the radial direction, in the footprint of the top surface 18 of the support body 17.

The wear sensors 30 are completely contained in the radial direction within the grooves that define the housing seats 23.

As schematically illustrated in FIG. 2, the portions of wear sensors 30 that exit from the outlet openings 25 of the housing seats 23, reach the insertion portion 20 of the support body 17 and enter the passage channel 16 of the component 10.

In the embodiment of FIG. 2A, the portions of wear sensors 30 that exit from the outlet openings 25 of the housing seats 23 enter the passage channel 16 of the component 10.

The connectors 34 are preferably housed inside the passage channel 16.

In use, the wear of the outer surface 11 of the component 10 causes the wear of the support body 17 starting from the top surface 18. As long as the wear of the support body 17 does not reach the top wall 24 of the housing seat 23 closest to the top surface 18, the wear sensors 30 are not exposed to erosive agents.

In this operating condition, the measuring portions 31 of the wear sensors 30 ensure electrical continuity and the electrical resistance of each wear sensor 30 has a finite value.

When the wear of the support body 17 reaches the top wall 24 of the housing seat 23 closest to the top surface 18, such a top wall 24 is worn, exposing the corresponding wear sensor 30 to erosive agents. This causes a change in the electrical state of the measuring portion 31 of the corresponding wear sensor 30. In particular, the electrical continuity of the wear sensor 30 is interrupted and its electrical resistance becomes infinite.

The change in the electrical state of the measuring portion 31 of the wear sensor 30 occurs as a result of the breaking of the U-bend 33 of the wire 32 of electrically conductive material caused by erosive agents.

Once the top wall 24 is worn, exposing the corresponding wear sensor 30 to erosive agents, the entire housing seat 23 is exposed to erosive agents, as it is no longer delimited above by the top wall 24.

The top walls 24 of the housing seats 23 placed at a greater distance from the top surface 18 with respect to the already eroded top wall 24 prevent the erosive agents from reaching the wear sensors 30 contained in the corresponding housing seats 23.

When the wear of the outer surface 11 of the component 10 continues, the support body 17 is also worn correspondingly.

When the wear of the support body 17 reaches a further top wall 24 of a further housing seat 23, such a top wall 24 is worn, exposing the corresponding wear sensor 30 to erosive agents. This causes a change in the electrical state of the measuring portion 31 of the wear sensor 30. In particular, the electrical continuity of the wear sensor 30 is interrupted and its electrical resistance becomes infinite.

The wear process of the outer surface 11 of the component 10 continues and the wear of the support body 17 continues correspondingly until the top wall 24 farthest from the top surface 18 of the support body 17 is also worn, exposing the corresponding wear sensor 30 to erosive agents. As mentioned, this causes a change in the electrical state of the measuring portion 31 of the wear sensor 30.

By choosing predetermined distances D1, D2, D3 of the top walls 24 from the top surface 18 of the support body 17 so that each distance corresponds to an indicative wear value of the component 10, it is thus possible to monitor the wear condition of the component 10.

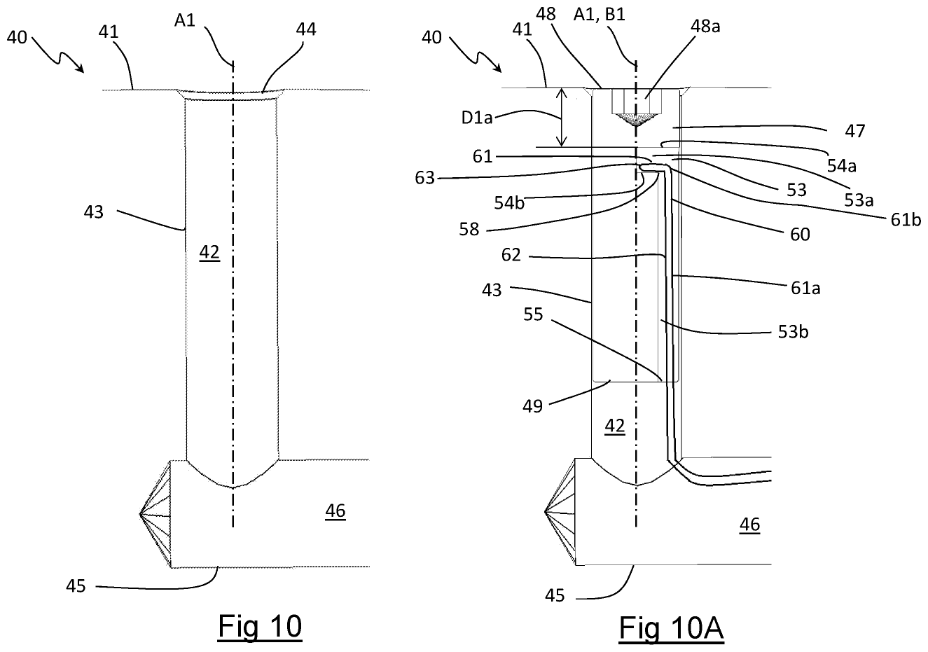

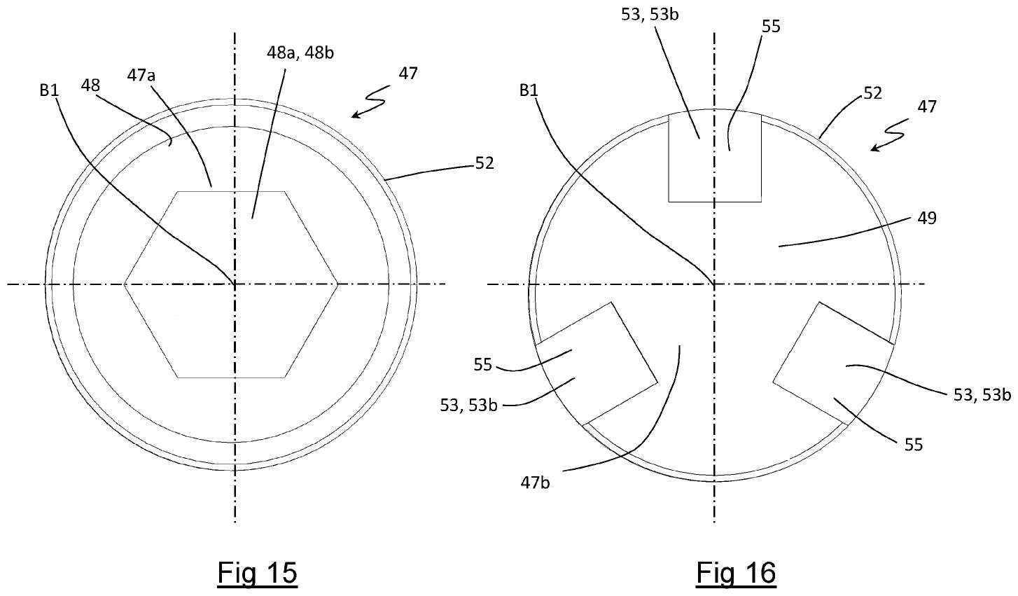

With reference to FIGS. 10-16, a third embodiment of a work machine component in accordance with the present invention is indicated overall, referred to generically with the numerical reference 40.

The work machine component 40 is similar to the work machine component 10 in FIGS. 1 and 2, except for the parts that are described differently below.

As shown in FIG. 10, the work machine component 40 comprises an outer surface 41 which is intended to interact with a work surface (not illustrated) which can for example be the outer surface of another undercarriage component or the ground.

The outer surface 41 of the work machine component 40 is the surface of which the state of wear is to be monitored.

In the operating machine component 40, a cavity 42 is formed which is delimited by a side wall 43. The cavity 42 can, for example, be obtained by boring with a drill bit and have a substantially cylindrical shape.

The cavity 42 comprises an opening 44 for the cavity placed at the outer surface 41 of the component 40.

The cavity 42 can comprise a bottom wall 45, opposite the opening 44.

The cavity 42 preferably has a substantially constant radial section along its axial extension, subject to the presence of surface irregularities such as a screw thread, for example.

The cavity 42 has an extension axis A1 along which the cavity 42 itself extends. In the case of a substantially cylindrical shaped cavity (as in the embodiment illustrated in FIG. 10) the extension axis A1 coincides with an axis of symmetry for the cavity 42.

A passage channel 46 is provided. The passage channel 46 reaches the side wall 43 of the cavity 42, at the bottom wall 45.

The passage channel 46 is transverse, preferably orthogonal, to the extension axis A1.

In the embodiment of FIG. 10, the cavity 42 comprises an inner screw thread (not illustrated) on the side wall 43.

In alternative embodiments, the bottom wall 45 and passage channel 46 can be made similar to the bottom wall 15 and to the passage channel 16 of the embodiments of FIGS. 1, 2, 1A and 2A.

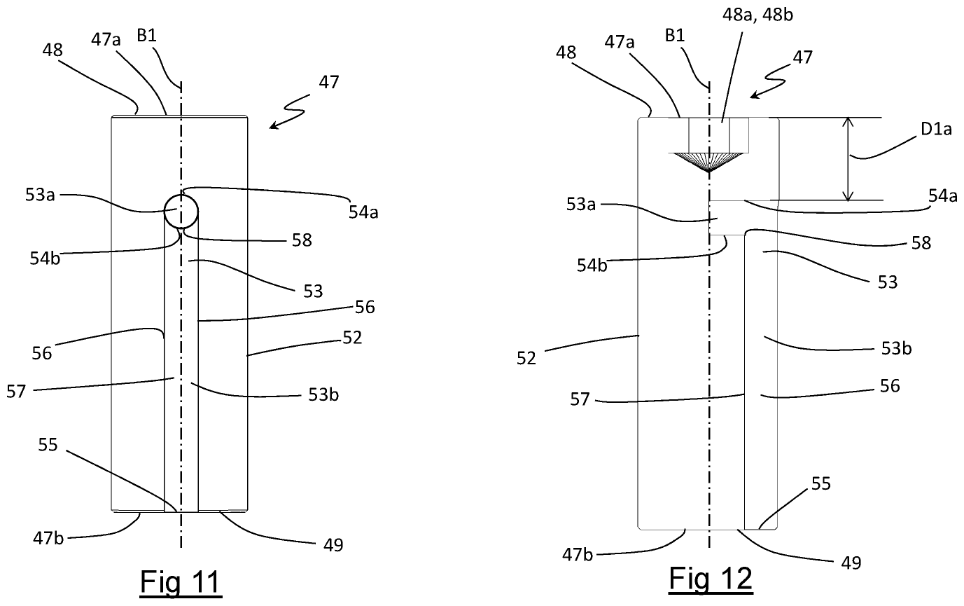

The work machine component 40 further comprises a support body 47 inserted in the cavity 42, illustrated in FIGS. 11-16.

The support body 47 is firmly retained in the cavity 42, in a predetermined position.

The support body 47 comprises a first axial end 47a and a second axial end 47b opposite the first axial end 47a. The support body 47 comprises a substantially flat top surface 48. The top surface 48 is placed at the first axial end 47a.

At the top surface 48, the support body 47 comprises a manoeuvring portion 48a through which the support body 47 can be rotated by means of a tool counter-shaped to the manoeuvring portion 48a to screw and unscrew it within the cavity 42.

The manoeuvring portion 48a comprises a manoeuvring recess 48b open in said top surface. In the embodiment illustrated, the manoeuvring recess 48b is a hexagonal hole that can be engaged by a corresponding standard Allen key.

On the opposite side with respect to the top surface 48, the support body 47 comprises a base surface 49. The base surface 49 is placed at the second axial end 47b. In the embodiments illustrated, the base surface 49 is substantially flat.

The support body 47 extends along an axial extension axis B1. Such an axial extension axis B1 defines, in the preferred embodiment of the invention, an axis of symmetry for the support body 47. The support body 47 is substantially cylindrical in shape.

The support body 47 comprises a lateral surface 52, extending from the base surface 49 to the top surface 48. The support body 47 comprises an outer screw thread (not shown) on the lateral surface 52 configured to engage the inner screw thread of the cavity 42 to constrain the support body 47 in the cavity 42.

The inner screw thread of the cavity 42 and the outer screw thread of the support body 47 are configured to allow the support body 47 to be screwed within the cavity 42 up to a limit switch position (illustrated for example in FIGS. 10 and 10A) at which the support body 47 cannot be screwed further into the cavity 42. In the embodiment illustrated in FIGS. 10-16, the limit switch position coincides with the predetermined position.

Preferably, the support body 47 is made of a material with mechanical properties similar to the mechanical properties of the undercarriage component 40.

In a first preferred embodiment of the present invention, the undercarriage component 40 can be made of abrasion-resistant steel, for example a steel with a low carbon content (comprised between 0.2% and 0.45% by mass). The ultimate tensile strength is comprised between about 1450 Mpa and about 1930 MPa. The hardness is comprised between about 420 HWB and 530 HBW 10/3000. An example of steel that can be used is boron steel with an average carbon content of the 37MnB4 or 25MnB5 type.

The support body 47 can be made of the same material as the undercarriage component 40.

In another embodiment, the support body 47 can be made of stainless steel having an ultimate tensile strength comprised between about 650 and about 800 Mpa and a hardness comprised between about 200 and about 270 HBW 10/3000.

In this last embodiment, the ratio between the hardness of the support body 47 and of the undercarriage component 40 is comprised between about 0.38 and about 0.64. The ratio between the ultimate tensile strength of the support body 47 and of the undercarriage component 40 is comprised between about 0.34 and about 0.55.

In a further embodiment, the support body 47 is made of thermoplastic material such as, for example, Ertalon PA6 or PA66 having ultimate tensile strength comprised between 54 MPa and 61 MPa.

In this case, the material of the support body 47 does not have similar mechanical properties to those of the undercarriage component.

The support body 47 comprises at least one housing seat 53. In the preferred embodiment of the invention, the support body 47 comprises a plurality of housing seats 53. In the example embodiment shown in the appended drawings, three housing seats 53 are provided.

Each housing seat 53 comprises a radial recess 53a, extending radially towards the axial extension axis B1, preferably up to the axial extension axis B1. In the embodiment illustrated, the radial recess is a cylindrical hole, having a cylindrical axis perpendicular to the axial extension axis B1.

Each housing seat 53 further comprises an axial channel 53b extended parallel to the axial extension axis B1. The axial channel 53b is extended from the radial recess 53a towards the second axial end 47b of the support body 47. The axial channel 53b is perpendicular to the radial recess 53a. The axial channel 53b is a rectilinear axial groove formed on the lateral surface 52 of the support body 47.

The housing seat 53 has an ‘L’ shape in which the axial channel 53b and the radial recess form respective branches of said ‘L’ shape.

Each housing seat 53 is delimited in the axial direction by a top wall 54a. The top wall 54a is placed at the radial recess 53a and delimits it in the axial direction towards the first axial end 47a.

Each housing seat 53 further comprises an abutment wall 54b. The abutment wall 54b faces toward the first axial end 47a. The abutment wall 54b is arranged on the side opposite the top wall 54a with respect to the radial recess 53a. The abutment wall 54b delimits the radial recess 53a towards the second axial end 47b. The abutment wall 54b has an angle of 90° with the axial extension axis B1.

The top wall 54a and the abutment wall 54b define respective semi-cylindrical surfaces delimiting the radial recess 53a from axially opposite sides.

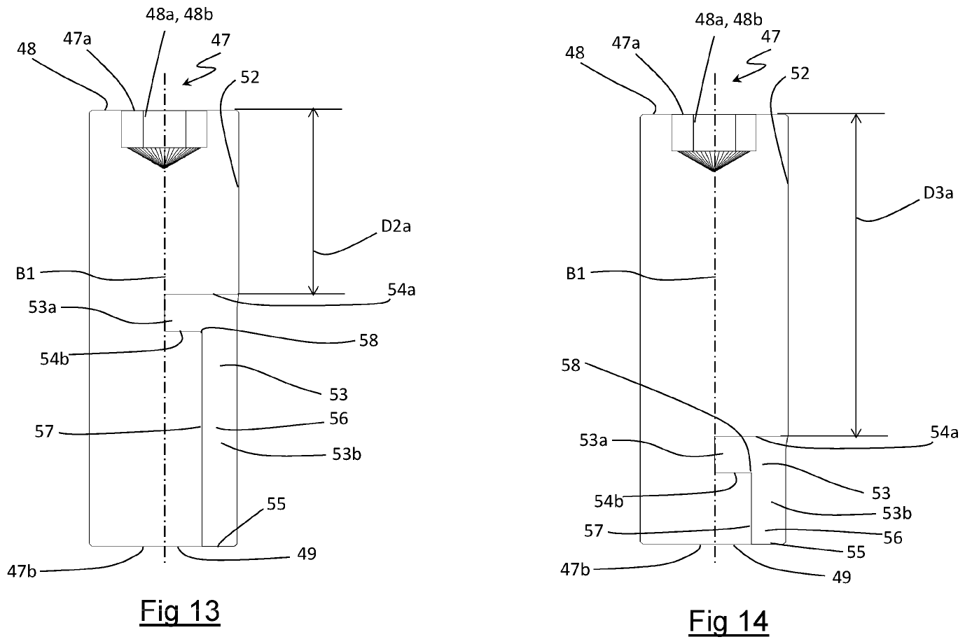

The abutment wall 54b is parallel to the top wall 54a in the radial direction. In other words, a cutting plane passing through the axial extension axis B1, which cuts the abutment wall 54b and the top wall 54a, such as the cutting planes of the views of FIGS. 13, 14, and 15, defines respective cutting segments parallel to each other on the abutment wall 54b and the top wall 54a.

On the side opposite the top wall 54a, each housing seat 53 comprises a base opening 55 at the second axial end 47b. The base opening 55 is placed at the base surface 49. The base opening 55 lies on a plane perpendicular to the axial extension axis B1.

Between the top wall 54a and the base opening 55, each housing seat 53 comprises two side walls 56. The side walls 56 delimit the axial channel 53b. A bearing wall 57 is defined between the side walls 56 and the top wall 54a. The bearing wall 57 delimits the axial channel 53b towards the axial extension axis B. Each housing seat 53 is open in the radially outward direction.

Between the radial recess 53a and the axial channel 53b, the housing seat comprises an edge 58, preferably a sharp edge.

As shown in FIG. 16, the housing seats 53 are equidistant from each other in the circumferential direction.

A respective wear sensor 60 is housed inside each housing seat 53, as illustrated in FIG. 10A.

Each wear sensor 60 comprises a measuring portion 61 which can be worn and is configured to change, when eroded, measurable electrical properties of the wear sensor 60.

The measuring portion 61 is placed in the radial recess 53a between the top wall 54a and the abutment wall 54b. The measuring portion 61 is oriented radially.

Each wear sensor 60 further comprises a conductive portion 61a, electrically connected to the measuring portion and arranged in the axial channel 53b. The conductive portion 61a is oriented axially.

Each wear sensor 60 forms a curve 61b, preferably about 90°, between the conductive portion 61a and the measuring portion 61. The curve 61b is placed at the edge 58.

In preferred embodiments of the invention, each wear sensor 60 is an electrical conductor comprising a single wire 62 of electrically conductive material surrounded by a sheath of electrically insulating material.

For example, the single wire 62 of electrically conductive material can be an electric cable comprising a core of metallic material, e.g., copper or aluminium, surrounded by an electrically insulating layer. By way of example, the single wire 62 of electrically conductive material can be a single-core AWG (American wire gauge) 28.

The wear sensor 60 is at least partially housed in the housing seat 53 so that it does not project radially from the dimensions of the upper surface 48 of the support body 47.

In particular, the wire 62 of electrically conductive material which forms the wear sensor 60 is placed in the housing seat 53 so as to create a U-bend 63 between the top wall 54a and the abutment wall 54b, within the radial recess 53a. Such a U-bend 63 defines the measuring portion 61.

To form the U-bend 63, the wire 62 of electrically conductive material is inserted in the housing seat 53 bent so as to define two sections joined by said U-bend 63. Portions of the two sections of wire 62 are inserted in the radial recess 53a and the axial channel 53b and define, the measuring portion 61, the conductive portion 61a and the curve 61b.

Each wire 62 of electrically conductive material is retained in the respective housing seat 63 by the use of an adhesive.

As schematically illustrated, each wire 62 of electrically conductive material exits from the respective housing seat 63 at the base opening 55. In particular, each wire 62 exits from the respective housing seat 63 in an axial direction.

Each wire 62 of electrically conductive material exits from the outlet opening 55 and passes through the passage channel 46. Between the outlet opening 55 and the passage channel, the wire 62 forms a 90° curve.

Similarly to what is depicted in FIG. 8 with reference to the measuring sensors 30, on the opposite side with respect to the measuring portion 61, each wear sensor 60 is connected to one or more connectors so that it can be inserted in a measuring circuit of a measurable electrical property of the wear sensor 60.

In the preferred embodiment of the invention, such a measurable electrical property of the wear sensor 60 is the electrical resistance.

All the wires 62 of electrically conductive material are electrically connected to each other at one end so as to have a common electrical pole. By measuring the electrical conductivity (or electrical resistance) between said common electrical pole and the other free end of each wire 62 of electrically conductive material, it is possible to determine the electrical continuity of each wire 62 of electrically conductive material.

The connectors can be connected to a signal processing or conditioning device (not illustrated) which is configured to determine the electrical continuity of each wire 62 of electrically conductive material.

The connectors are preferably housed inside the passage channel 46.

As shown, the support body 47 and the wear sensor 60 (or wear sensors 60 when a plurality of wear sensors 60 are provided) are inserted in cavity 42. In particular, the support body 47 is screwed in the cavity 42 and the outer screw thread of the support body 47 is engaged with the inner screw thread of the cavity 42.

In the preferred embodiment illustrated, when the support body 47 is inserted in the cavity 42 in the predetermined position, the top surface 48 is aligned with the outer surface 41 of the work machine component 10 whose state of wear is to be monitored.

In alternative embodiments not illustrated, the support body 47 can be arranged in the predetermined position with the top surface 48 not aligned with the outer surface 41. For example, the top surface 48 can be sunk within the cavity 42.

The top wall 54a of each housing seat 53 is placed at a predetermined axial distance D1a, D2a, D3a from the outer surface 41 of the work machine component 10 whose state of wear is to be monitored.

In the illustrated embodiment in which the top surface 48 is aligned with the outer surface 41 in the predetermined position, the predetermined axial distance D1a, D2a, D3a of each top wall 54a from the outer surface 41 of the work machine component 10 coincides with a distance of the top wall 54a from the top surface 48 of the support body 47 (as illustrated in FIGS. 10A, 12, 13, 14).

Such predetermined distances D1a, D2a, D3a are different from each other. The top walls 54a of the housing seats 53 are placed at different axial distances from the outer surface 41 of the work machine component 10.

In the embodiment illustrated in the appended drawings in which three housing seats 53 are provided, the top wall 54a of a first housing seat 53 is placed at a first predetermined distance D1a (illustrated in FIG. 12), the top wall 24 of a second housing seat 53 is placed at a second predetermined distance D2a (illustrated in FIG. 13) and the top wall 54a of a third housing seat 53 is placed at a third predetermined distance D3a (illustrated in FIG. 14) from the outer surface 41 of the work machine component 10.

Such predetermined distances D1a, D2a, D3a are equidistant from each other in the axial direction.

The predetermined distance D1a of the top wall 54a closest to the top surface 48 of the support body 47 can be equal to the distance, in the axial direction separating any two top walls 54a, or greater than the distance, in the axial direction separating any two top walls 54a, or less than the distance, in the axial direction separating any two top walls 54a.

None of the housing seats 53 are open in the axial direction towards the top surface 48 of the support body 47.

The top walls 54a of the housing seats 53 close the housing seats 53 in the axial direction towards the top surface 48 of the support body 47.

The support body 47 has a radial section obtained along a radial plane that remains constant (in terms of area and shape) moving axially from the top surface 48 up to reaching the top wall 54a closest to the top surface 48 of the support body 47, except for any surface irregularities caused, for example, by the outer screw thread.

The housing seats 53 with wear sensors 60 therein are filled with epoxy resin. If there is a radial clearance between the cavity 42 and the support body 47, such radial clearance can also be filled with an epoxy resin.

The wear sensors 60 are completely contained in the radial direction within the housing seats 53.

In use, the wear of the outer surface 41 of the component 40 causes the wear of the support body 47 starting from the top surface 48. As long as the wear of the support body 47 does not reach the top wall 54a of the housing seat 53 closest to the top surface 48, the wear sensors 60 are not exposed to erosive agents.

In this operating condition, the measuring portions 61 of the wear sensors 60 ensure electrical continuity and the electrical resistance of each wear sensor 60 has a finite value.

When the wear of the support body 47 reaches the top wall 54a of the housing seat 53 closest to the top surface 48, such a top wall 54a is worn, exposing the corresponding wear sensor 60 to erosive agents.

The measuring portion 61 of the sensor of 60 is held in an abutted position on the abutment wall 54b, which counteracts external agents acting on the measuring portion 61, pressing in an axial direction towards the second end 47b.

The wear of the measuring portion 61, or its eventual breakage, causes an change of the electrical state of the measuring portion 61 of the corresponding wear sensor 60. In particular, the electrical continuity of the wear sensor 60 is interrupted and its electrical resistance becomes infinite.

The change in electrical state of the measuring portion 61 of the wear sensor 60 can occur as a result of either the breaking of the U-bend 63 of the wire 62 of electrically conductive material or of the curve 61b, caused by erosive agents.

Once the top wall 54a is worn, exposing the corresponding wear sensor 60 to erosive agents, the entire housing seat 53 is exposed to erosive agents, as it is no longer delimited above by the top wall 54a.

The top walls 54a of the housing seats 53 placed at a greater distance from the top surface 48 with respect to the already eroded top wall 54a prevent the erosive agents from reaching the wear sensors 60 contained in the corresponding housing seats 53.

When the wear of the outer surface 41 of the component 40 continues, the support body 47 is also worn correspondingly.

When the wear of the support body 47 reaches a further top wall 54a of a further housing seat 53, such a top wall 54a is worn, exposing the corresponding wear sensor 60 to erosive agents. This causes a change in the electrical state of the measuring portion 61 of the wear sensor 60. In particular, the electrical continuity of the wear sensor 60 is interrupted and its electrical resistance becomes infinite.

The wear process of the outer surface 41 of the component 40 continues and the wear of the support body 47 continues correspondingly until the top wall 54a farthest from the top surface 48 of the support body 47 is also worn, exposing the corresponding wear sensor 60 to erosive agents. As mentioned, this causes a change in the electrical state of the measuring portion 61 of the wear sensor 60.

Choosing the predetermined distances D1a, D2a, D3a of the axial top walls 54 of the outer surface 41 of the component 40 (with the support body 47 in the predetermined position) so that each distance corresponds to an indicative wear value of the component 40, it is then possible to monitor the state of wear of the component 40.

The present invention has been described with reference to some preferred embodiments thereof. Various modifications can be made to the embodiments described above, still remaining within the scope of protection of the invention, defined by the following claims.

1. A work machine component, comprising:
a cavity formed in the component and having an extension axis;
an opening for the cavity placed at an outer surface of the component;
a support body, having an axial extension axis parallel to said extension axis of the cavity, inserted in the cavity and comprising, at a first axial end, a top surface and at least one housing seat formed in said support body configured to receive a wear sensor;
wherein said housing seat comprises a top wall placed at a distance along said axial extension axis from the top surface of the support body;
a wear sensor housed in said housing seat.

2. The work machine component according to claim 1, wherein said housing seat comprises an abutment wall facing toward said first axial end, said wear sensor comprising a measuring portion placed axially between said top wall and said abutment wall.

3. The work machine component according to claim 2, wherein said housing seat comprises a radial recess defined between said top wall and said abutment wall, said radial recess being radially extended towards said axial extension axis, said measuring portion being inserted within said radial recess.

4. The work machine component according to claim 3, wherein said housing seat comprises an axial channel extended parallel to said axial extension axis, from said radial recess towards a second axial end of said support body, axially opposite to said first axial end.

5. (canceled)

6. The work machine component according to claim 4, wherein said wear sensor comprises a conductive portion electrically connected to said measuring portion, said conductive portion being housed in said axial channel.

7. (canceled)

8. The work machine component according to claim 1, wherein said cavity comprises an inner screw thread and said support body comprises an outer screw thread engaged with the inner screw thread of said cavity.

9. The work machine component according to claim 1, wherein said top surface is aligned with the outer surface of the component and wherein said top wall is placed at a predetermined distance, along said axial extension axis, from the top surface of the support body.

10. The work machine component according to claim 1, wherein said support body comprises a plurality of housing seats formed in said support body; each housing seat of said plurality of housing seats comprising a respective top wall placed at a distance, along said axial extension axis, from the top surface of said support body, and wherein said work machine component comprises a plurality of wear sensors, wherein each wear sensor of said plurality of wear sensors is inserted into a corresponding housing seat.

11. The work machine component according to claim 10, wherein each housing seat of said plurality of housing seats comprises an abutment wall facing toward said first axial end and wherein each wear sensor of said plurality of wear sensors comprises a measuring portion axially placed between the top wall and the abutment wall of the respective housing seat.

12. The work machine component according to claim 11, wherein each housing seat of said plurality of housing seats comprises a radial recess defined between a respective top wall and a respective abutment wall, said radial recess being radially extended towards said axial extension axis, the measuring portion of the respective wear sensor being inserted within said radial recess.

13. The work machine component according to claim 12, wherein each housing seat of said plurality of housing seats comprises an axial channel extended parallel to said axial extension axis, from the respective radial recess towards a second axial end of said support body, axially opposite to said first axial end.

14. (canceled)

15. The work machine component according to claim 13, wherein each wear sensor of said plurality of wear sensors comprises a conductive portion electrically connected to the respective measuring portion, said conductive portion being housed in the axial channel of the housing seat of the respective wear sensor.

16. The work machine component according to claim 10, wherein each respective top wall is placed at a predetermined distance along said axial extension axis, from the top surface of the support body, and wherein said predetermined distances of the top walls of said plurality of housing seats are different from each other.

17. (canceled)

18. The work machine component according to claim 1, wherein the support body has a radial section, obtained along a radial plane passing through said top surface, having an area substantially equal to the area subtended by the cavity on a section obtained along a radial plane passing through said opening for the cavity.

19. The work machine component according to claim 18, wherein the area of said radial section is constant, along the axial extension of the support body, between the top surface and the top wall of said at least one housing seat.

20. The work machine component according to claim 1, wherein said at least one housing seat comprises a base opening axially opposite said top wall; said base opening being configured for at least one electrical conductor to pass through.

21. (canceled)

22. (canceled)

23. The work machine component according to claim 1, wherein said wear sensor is glued into said housing seat, said housing seat being filled with epoxy resin.

24. (canceled)

25. The work machine component according to claim 1 wherein said wear sensor comprises a single wire of electrically conductive material surrounded by a sheath of electrically insulating material.

26. The work machine component according to claim 1, wherein each wear sensor comprises a measuring portion which is wearable and is configured to change, when eroded, measurable electrical properties of the wear sensor, said measuring sensor being configured to detect a state of wear of the work machine component directly as a result of a degradation of the measuring portion.

27. A work machine component, comprising:
a cavity in the component and having an extension axis;
an opening for the cavity placed at an outer surface of the component;
a support body, having an axial extension axis parallel to said extension axis of the cavity, inserted in the cavity and including, at a first axial end, a top surface aligned with the outer surface of the component and at least one housing seat obtained in said support body configured to receive a wear sensor;
wherein said housing comprises a top wall placed at a predetermined distance, along said axial extension axis, from the top surface of the support body;
a wear sensor housed in said housing seat.
